(19) United States
(12) Patent Application Publication
(10) Pub. No.: US 2004/0195340 A1
(43) Pub. Date: Oct. 7, 2004

(54) Data card

(76) Inventor: Colleen Rochelle Caruso Lubking, Richmond, VA (US)

Correspondence Address: BAKER & MCKENZIE, 805 THIRD AVENUE, NEW YORK, NY, 10022, US

(21) Appl. No.: 10/817,695

(22) Filed: Apr. 2, 2004

Related U.S. Application Data
(60) Provisional application No. 60/460,665, filed on Apr. 3, 2003.

(51) Int. Cl. G06K 19/06; G06K 7/00; G06K 19/00

(52) U.S. Cl. 235/493; 235/486

(57) ABSTRACT

A data card, comprising a primary card body including a first magnetic recordable data strip, the primary card body having a cut-out portion, and a secondary card body including a second magnetic recordable data strip, the secondary card body operable to be removably engaged within the cut-out portion of the primary card body.

### CROSS-REFERENCE TO RELATED PATENT APPLICATIONS

This application claims the benefit of U.S. Provisional Patent Application No. 60/460,665, entitled DATA CARD, filed on Apr. 3, 2003, which application is incorporated herein by reference in its entirety.

### FIELD

The present application relates to a data card, and more particularly, to a primary data card including a removable secondary data card.

### BACKGROUND

Data cards, such as credit cards, debit cards and stored-value cards associated with merchants, are commonly used by consumers to conduct transactions at automated teller machines (“ATM”) and at point-of-sale (“POS”) terminals. For instance, consumers present such data cards to make purchases, withdraw money, transfer money, pay one or more bills and retrieve account information associated with the respective data card. At an ATM, a consumer inserts a data card into a card reading port associated with the ATM and upon identifying the presence of the data card, a magnetic recording head of the ATM machine reads a magnetic recordable data strip located on the data card. At a POS terminal, a consumer or a merchant swipes a data card such that a magnetic recordable data strip located on the data card is read by a magnetic reading head of the POS terminal, or waves a data card containing a processing unit in front of a smart POS terminal or radio frequency identification (“RFID”) reader.

These data cards are regulated by the International Organization for Standardization (“ISO”). For instance, ISO regulates the dimensions, construction and content of the data cards. Also, companies such as MasterCard® and Visa® impose requirements on card issuers that pertain to the appearance and operability of these data cards. These regulations and requirements, however, are subject to change in order for data cards contrary to the traditional data card to be introduced into the marketplace, such as the recently introduced Discover 2GO^{SM} card and the Bank of America Mini Card. The Discover 2GO^{SM} card and the Mini Card are considered a compact-sized companion card to a respective cardholder's existing Discover® card and Bank of America card, respectively, and includes a magnetic recordable data strip also operable for accessing the same account as the traditionally sized card. Accordingly, the cardholder has at least two data cards—a traditional data card and a compact-sized companion data card.

A need exist, however, for a primary data card having the dimensions of a traditional data card, but operable for removably engaging and disengaging a corresponding secondary card having a magnetic recordable data strip and/or processing unit for accessing the same or different account accessible with a magnetic recordable data strip and/or processing unit of the primary data card. A need also exist for the primary data card to be operable at a POS terminal and at an ATM regardless whether the corresponding secondary data card is engaged or disengaged from the primary data card. Further, there is a need for the secondary data card to be operable at a POS terminal when disengaged from the primary data card or when engaged with the primary data card, but orientated such that a magnetic recordable data strip of the secondary data card is located along an edge of the primary data card.

### SUMMARY

An aspect of the present application provides for a data card, comprising a primary card body including a first magnetic recordable data strip, the primary card body having a cut-out portion, and a secondary card body including a second magnetic recordable data strip, the secondary card body operable to be removably engaged within the cut-out portion of the primary card body.

Another aspect of the present application provides for a data card, comprising a primary card body including two exterior vertical side walls, an exterior horizontal top wall, an exterior horizontal bottom wall and a first magnetic recordable data strip, the primary card body having a cut-out portion, the cut-out portion formed by at least three interior walls of the primary card body, and a secondary card body including two vertical side walls, a horizontal top wall, a horizontal bottom wall and a second magnetic recordable data strip, the secondary card body operable to be removably engaged within the cut-out portion of the primary card body, wherein the first magnetic recordable data strip is encoded with account data and is operable for accessing an account and the second magnetic recordable data strip is encoded with account data and is operable for accessing one of the account and another account.

A further aspect of the present application provides for a data card, comprising a primary card body including a first magnetic recordable data strip, the primary card body having a cut-out portion, and a secondary card body including a processing unit and a memory unit, the secondary card body operable to be removably engaged within the cut-out portion of the primary card body.

A still further aspect of the present application provides for a data card, comprising a primary card body including a processing unit and a memory unit, the primary card body having a cut-out portion, and a secondary card body including a magnetic recordable data strip, the secondary card body operable to be removably engaged within the cut-out portion of the primary card body.

An additional aspect of the present application provides for a data card, comprising a primary card body including a first processing unit and a first memory unit, the primary card body having a cut-out portion, and a secondary card body including a second processing unit and a second memory unit, the secondary card body operable to be removably engaged within the cut-out portion of the primary card body.

An aspect of the present application provides for a method for assembling a data card, the method comprising aligning a plurality of outer walls of a secondary data card having a magnetic recordable data strip with a plurality of inner walls forming a cut-out portion of a primary data card, the primary data card having a magnetic recordable data strip, and engaging the secondary data card and the primary data card by compressing the primary data card and the secondary data card until one of a front face and a back face of the secondary data card is one of coplanar and substantially coplanar with one of a front face and a back face of the primary data card.

Another aspect of the present application provides for a method for assembling a data card, the method comprising aligning an exterior wall of a secondary data card having a magnetic recordable data strip with an opening of a cut-out portion located along an exterior wall of a primary data card so that the primary data card and the secondary data card are coplanar, the primary data card having a magnetic recordable data strip, and engaging the secondary data card and the primary data card by sliding the secondary data card into the cut-out portion of the primary data card until the exterior wall of the secondary data card makes contact with an interior wall of the cut-out portion.

### BRIEF DESCRIPTION OF THE DRAWINGS

FIG. 1a illustrates a front view of an exemplary data card according to the exemplary embodiments of the present application;

FIG. 1b illustrates a rear view of the exemplary data card shown in FIG. 1a according to the exemplary embodiments of the present application;

FIG. 1c illustrates a side view of the exemplary data card shown in FIG. 1a according to the exemplary embodiments of the present application;

FIG. 2a illustrates a front view of the exemplary data card shown in FIG. 1a without the secondary data card according to the exemplary embodiments of the present application;

FIG. 2b illustrates a rear view of the exemplary data card shown in FIG. 1a without the secondary data card according to the exemplary embodiments of the present application;

FIG. 3 illustrates a perspective view of the exemplary data card shown in FIG. 1 according to the exemplary embodiments of the present application;

FIG. 4 illustrates another exemplary data card according to the exemplary embodiments of the present application;

FIG. 5a illustrates a front view of another exemplary data card according to the exemplary embodiments of the present application;

FIG. 5b illustrates a rear view of the exemplary data card shown in FIG. 5a according to the exemplary embodiments of the present application;

FIG. 6a illustrates a front view of the exemplary data card shown in FIG. 5a without the secondary data card according to the exemplary embodiments of the present application;

FIG. 6b illustrates a rear view of the exemplary data card shown in FIG. 5a without the secondary data card according to the exemplary embodiments of the present application;

FIG. 7 illustrates another front view of the exemplary data card shown in FIG. 5a according to the exemplary embodiments of the present application;

FIG. 8a illustrates a perspective view of the exemplary data card shown in FIG. 5a according to the exemplary embodiments of the present application;

FIG. 8b illustrates a side view of an inner wall of the exemplary data card shown in FIG. 8a according to the exemplary embodiments of the present application;

FIG. 8c illustrates a plan view of the inner wall of the exemplary data card shown in FIG. 8b according to the exemplary embodiments of the present application;

FIG. 9a illustrates a perspective view of the exemplary secondary data card shown in FIG. 5a according to the exemplary embodiments of the present application;

FIG. 9b illustrates a side view of an inner wall of the exemplary secondary data card shown in FIG. 9a according to the exemplary embodiments of the present application;

FIG. 9c illustrates a plan view of the inner wall of the exemplary secondary data card shown in FIG. 9b according to the exemplary embodiments of the present application;

FIG. 10 illustrates another exemplary data card according to the exemplary embodiments of the present application;

FIG. 11a illustrates a front view of an another exemplary data card according to the exemplary embodiment of the present application;

FIG. 11b illustrates a rear view of the exemplary data card shown in FIG. 11a according to the exemplary embodiments of the present application;

FIG. 12a illustrates a front view of the exemplary data card shown in FIG. 11a without the secondary data card according to the exemplary embodiments of the present application;

FIG. 12b illustrates a rear view of the exemplary data card shown in FIG. 11a without the secondary data card according to the exemplary embodiments of the present application;

FIG. 13 illustrates a front view of the exemplary data card shown in FIG. 11a without the secondary data card according to the exemplary embodiments of the present application;

FIG. 14a illustrates a front view of another exemplary data card according to the exemplary embodiments of the present application;

FIG. 14b illustrates a rear view of the exemplary data card shown in FIG. 14a according to the exemplary embodiments of the present application;

FIG. 15a illustrates a front view of the exemplary data card shown in FIG. 14a without a secondary data card according to the exemplary embodiments of the present application;

FIG. 15b illustrates a rear view of the exemplary data card shown in FIG. 14a without a secondary data card according to the exemplary embodiments of the present application;

FIG. 16 illustrates another front view of the exemplary data card shown in FIG. 14a according to the exemplary embodiments of the present application;

FIG. 17a illustrates a front view of the exemplary data card shown in FIG. 17a according to the exemplary embodiments of the present application;

FIG. 17b illustrates a rear view of another exemplary data card according to the exemplary embodiments of the present application;

FIG. 18a illustrates a front view of another exemplary data card according to the exemplary embodiments of the present application; and

FIG. 18b illustrates a rear view of the exemplary data card shown in FIG. 18a according to the exemplary embodiments of the present application.

### DETAILED DESCRIPTION

The present application describes and illustrates various exemplary data cards including a primary data card and a secondary data card associated with the primary data card. The exemplary primary data cards include a magnetic recordable data strip and/or a processing unit and are operable, for instance, as a debit card, credit card, smart card, merchant card or the like. For example, the primary data cards can be used by a cardholder to conduct a transaction at a POS terminal and at an ATM machine. Each exemplary primary data card is associated with a removable secondary data card. Similar to the primary data cards, the exemplary secondary data cards include a magnetic recordable data strip and/or a processing unit and are operable, for instance, as a debit card, credit card, smart card, merchant card or the like. Accordingly, the secondary data cards can also be used at a POS terminal. A primary data card and a respective secondary data card engage and disengage as described and illustrated herein.

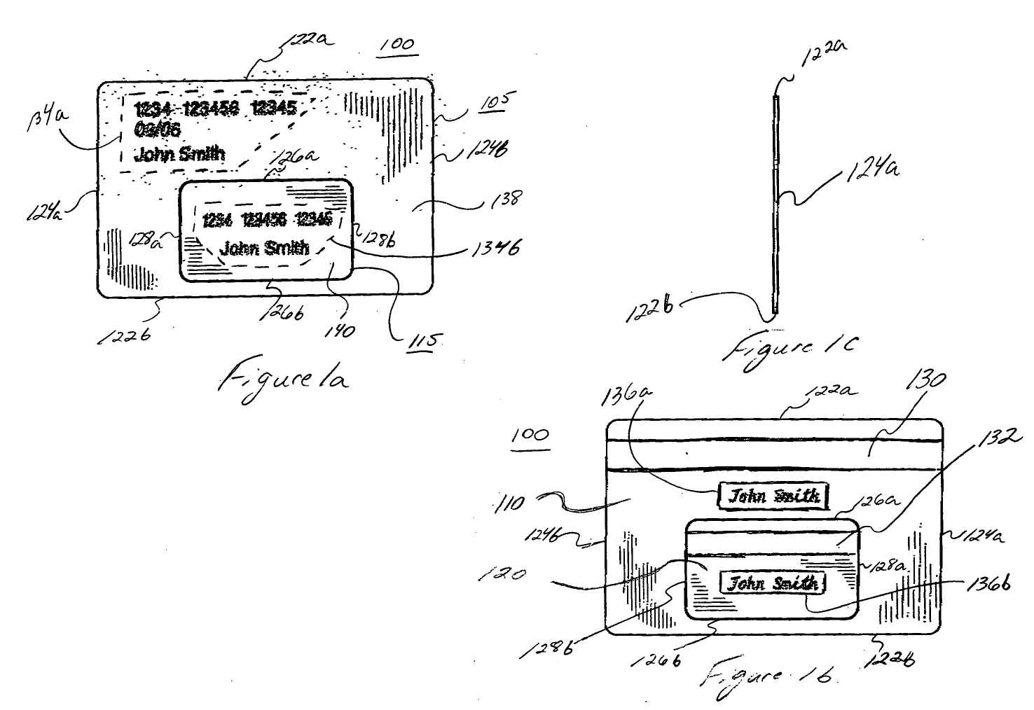

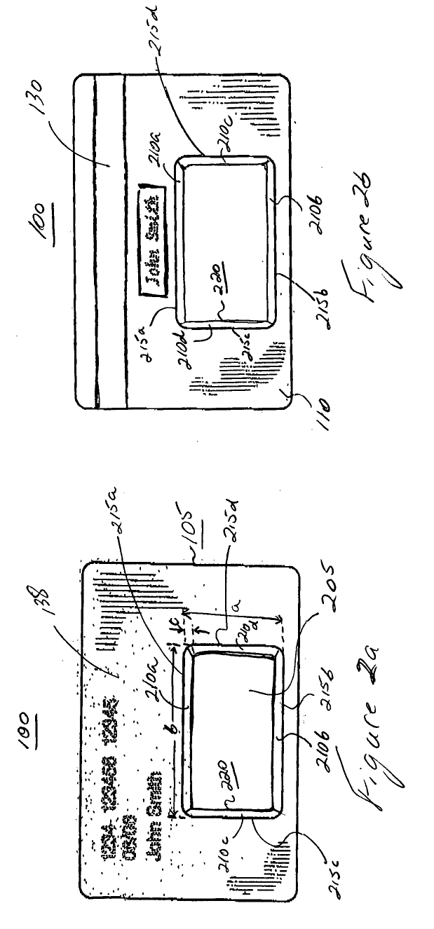

FIG. 1a illustrates a front view of exemplary data card 100 according to the exemplary embodiments of the present application and FIG. 1b illustrates a rear view of exemplary data card 100. FIG. 1c illustrates a side view of exemplary data card 100 shown in FIGS. 1a and 1b. As can be seen in FIGS. 1a and 1b, exemplary data card 100 includes primary data card 105 removably engaged with secondary data card 115. Primary data card 105 includes front face 138, rear face 110, and four outer walls—horizontal top wall 122a, horizontal bottom wall 122b, vertical side wall 124a and vertical side wall 124b. Secondary data card 115 includes front face 140, rear face 120, and four outer walls—horizontal top wall 126a, horizontal bottom wall 126b, vertical side wall 128a and vertical side wall 128b.

Front face 138 of primary data card 105 includes indicia 134a and front face 140 of secondary data card 115 includes indicia 134b. In an exemplary embodiment, indicia 134a, 134b identifies an account and an account holder associated with primary data card 105 and secondary data card 115. Indicia 134a, 135b can include, for example, data indicating a name, account number, expiration date, and an institution, a merchant or the like issuing the data card. Rear face 110 of primary data card 105 includes magnetic recordable data strip 130 and signature box 136a. Likewise, rear face 120 of secondary data card 115 includes magnetic recordable data strip 132 and signature box 136b. Alternatively, either signature box 136a or signature box 136b can be included on data card 100 and can be located on rear face 110 or rear face 120 of primary data card 105 or secondary data card 115, respectively. Magnetic recordable data strip 130 and magnetic recordable data strip 132 are encoded with data such that primary data card 105 and secondary data card 115, respectively, are operable for a cardholder to access the same account.

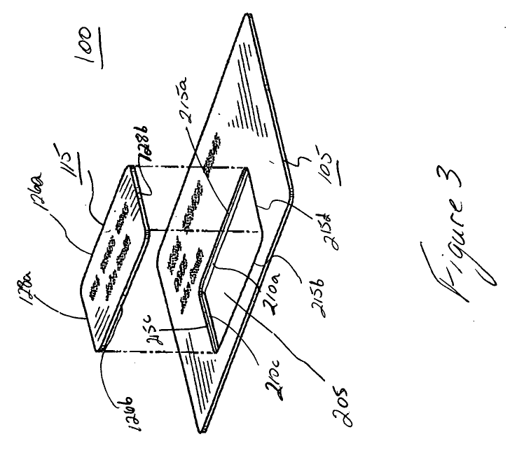

FIG. 2a illustrates a front view of exemplary data card 100 without secondary data card 115 removably engaged with primary data card 105 and FIG. 2b illustrates a rear view of exemplary data card 100 shown in FIG. 2a. Primary data card 105 includes cut-out portion 205. Cut-out portion 205 is formed by four inner walls of primary data card 105—horizontal walls 215a, 215b having length b and vertical sidewalls 215c, 215d having length a. Around the perimeter of cut-out portion 205 is lip 220 having a width c, lip 220 being coplanar or substantially coplanar with rear face 110 of primary data card 105. Lip 220 includes horizontal top portion 210a, horizontal bottom portion 210b, vertical side portion 210c and vertical side portion 210d. Alternatively, lip 220 can be coplanar or substantially coplanar with front face 138 of primary data card 105. Lip 220 prevents secondary data card 115 from being forced, either intentionally or inadvertently, through primary data card 105, as described herein in more detail. In an exemplary embodiment, lip 220 is constructed of the same or similar substrate material as used for constructing conventional data cards.

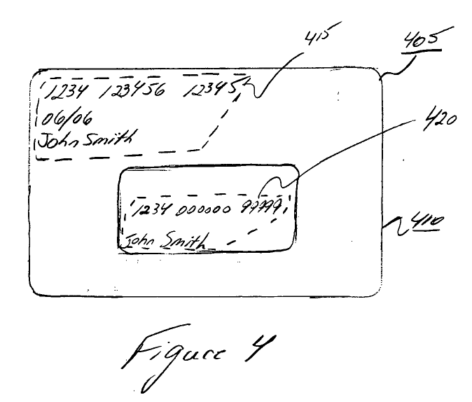

FIG. 3 illustrates a perspective view of exemplary data card 100 shown in FIGS. 1a, 1b, 2a, 2b. In order to engage secondary data card 115 with primary data card 105, the outer walls of secondary data card 115 are aligned with or substantially aligned with the walls of cut-out portion 205. Thereafter, secondary data card 115 is depressed into cut-out portion 205 until front face 140 of secondary data card 115 is co-planar or substantially co-planar with front face 138 of primary data card 105. A portion of back face 120 of secondary data card 115 rests on lip 220 of primary data card 105.

In an exemplary embodiment, secondary data card 115 firmly fits into cut-out portion 205 of primary data card 105, as shown in FIG. 3. Specifically, when secondary data card 115 is engaged with primary data card 105, horizontal top wall 126a of secondary data card 115 remains in contact with horizontal top wall 215a of cut-out portion 205 and horizontal top portion 210a of lip 220, horizontal bottom wall 126b of secondary data card 115 remains in contact with horizontal bottom wall 215b of cut-out portion 205 and horizontal bottom portion 210b of lip 220, vertical side wall 128a of secondary data card 115 remains in contact with vertical side wall 215c of cut-out portion 205 and vertical side portion 210c of lip 220, and vertical side wall 128b of secondary data card 115 remains in contact with vertical side wall 215d of cut-out portion 205 and vertical side portion 210d of lip 220. Thus, due to the dimensions of the secondary data card 115, secondary data card 115 rests firmly within cut-out portion 205 of primary data card 105. In an exemplary embodiment, secondary data card 115 can be removably engaged such that front face 140 is coplanar with front face 138 or rear face 110 of primary data card 105. Also, secondary data card 115 can be removably engaged with primary data card 105 so that its orientation is 180 degrees from what is shown in the figures. In order to disengage secondary data card 115 from primary data card 105, for instance, an individual exerts opposing forces on the rear face 120 of secondary data card 115 and front face 138 of primary data card 105.

The location of the cut-out portion 205 is merely exemplary, as is the size and shape of the cut-out portion 205 and the size and shape of secondary data card 115. Further, as shown in the figures, magnetic recordable data strips 130, 132 can be configured on primary data card 105 and the respective secondary data card 115 in various ways.

Primary data card 105 is operable, for example, at a POS terminal and at an ATM, as the dimensions of primary data card 105 and the location of magnetic recordable data strip 130 are in compliance with regulations imposed by ISO. Further, primary data card 105 is operable at POS terminals when cut-out portion 205 does not contain secondary data card 115 since the swiping of magnetic recordable data strip 130 at these POS terminals is not effected. Further, primary data card 105 is operable at ATM machines when cut-out portion 205 does not contain secondary data card 115 if, for example, the absence of secondary data card 115 does not effect the functioning of the ATM machines for determining the presence of primary data card 105 upon insertion into a card reading port associated with the ATM machines by an individual.

Similarly, secondary data card 115 is also operable at POS terminals by, for example, swiping magnetic recordable data strip 132. As can be seen in the figures of the present application, secondary data card 115 and its associated magnetic recordable data strip 132 have smaller dimensions than primary data card 105. Accordingly, as will be appreciated by a person having ordinary skill in the art, magnetic recordable data strip 132 is encoded with account data along a smaller recording medium. U.S. Pat. No. 6,471,127 to Pentz et al., which is incorporated herein by reference in its entirety, describes encoding data on a magnetic recordable data strip smaller than a conventional magnetic recordable data strip.

Therefore, according to the exemplary embodiments of the present application, an individual can conduct transactions with primary data card 105 at an ATM machine and at a POS terminal, regardless whether secondary data card 115 is removably engaged within cut-out portion 205 of primary data card 105. Moreover, the individual can disengage secondary data card 115 for conducting transactions with secondary data card 115 at POS terminals. As will be appreciated by a person having ordinary skill in the art, if secondary data card 115 is engaged with primary data card 105 so that magnetic recordable data strip 132 is located along horizontal bottom wall 122b, secondary data card 115 is also operable at a POS terminal upon swiping primary data card 105 so that magnetic recordable data strip 132 is read by the respective magnetic reading head. Magnetic recordable data strip 130 and magnetic recordable data strip 132 are encoded with the same or similar data for accessing the same account.

In an alternative embodiment of the present application, magnetic recordable data strip 130 of primary data card 105 and magnetic recordable data strip 132 of the corresponding secondary data card 115 are encoded with data for accessing different accounts, as illustrated in FIG. 4. Indicia 415 associated with primary data card 105 and indicia 420 associated with secondary data card 115 may or may not reflect the operability of these cards to access different accounts. For instance, primary data card 105 can be operable for accessing a checking account and secondary data card 115 can be operable for accessing a savings account. As will be appreciated by a person having ordinary skill in the art, primary data card 105 and secondary data card 115 can be operable for accessing various types of accounts, whether financial or otherwise.

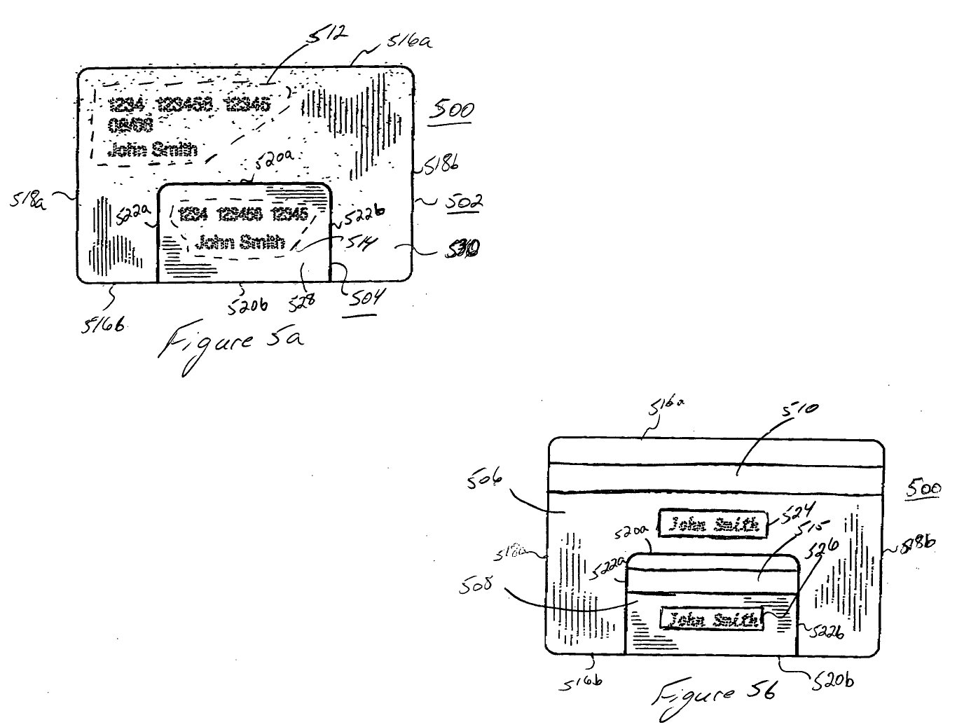

FIGS. 1a, 1b, 2a, 2b and 3 illustrate a cut-out portion located entirely within the four walls of a primary data card. The exemplary embodiments of the present application are equally applicable to a primary data card having a cut-out portion located along one of the side walls of the primary data card or along a bottom horizontal walls of the primary data card. Hence, such primary data cards and associated respective secondary data cards share at least one of the same walls. These exemplary embodiments are described herein with reference to FIG. 5a through FIG. 16.

FIG. 5a illustrates a front view of exemplary data card 500 according to the exemplary embodiments of the present application and FIG. 5b illustrates a rear view of exemplary data card 500. As can be seen in FIGS. 5a and 5b, exemplary data card 500 includes primary data card 502 removably engaged with secondary data card 504, primary data card 502 and secondary data card 504 having one common wall located on the bottom of data card 500, as described herein in more detail. Primary data card 502 includes front face 530, rear face 506, and four outer walls—horizontal top wall 516a, horizontal bottom wall 516b, vertical side wall 518a and vertical side wall 518b. Secondary data card 504 includes front face 528, rear face 508, and four outer walls—horizontal top wall 520a, horizontal bottom wall 520b, vertical side wall 522a and vertical side wall 522b.

Front face 530 of primary data card 502 includes indicia 512 and front face 528 of secondary data card 504 includes indicia 514. In an exemplary embodiment, indicia 512, 514 identifies an account and an account holder associated with primary data card 502 and secondary data card 504. Indicia 512, 514 can include, for example, data indicating a name, account number, expiration date, and an institution, a merchant or the like issuing the data card. Rear face 506 of primary data card 502 includes magnetic recordable data strip 510 and signature box 524. Likewise, rear face 508 of secondary data card 504 includes magnetic recordable data strip 515 and signature box 526. Alternatively, either signature box 524 or signature box 526 can be included on data card 500 and can be located on rear face 506 or rear face 508 of primary data card 502 or secondary data card 504, respectively. Magnetic recordable data strip 510 and magnetic recordable data strip 515 are encoded with data such that primary data card 502 and secondary data card 504, respectively, are operable for a cardholder to access the same account.

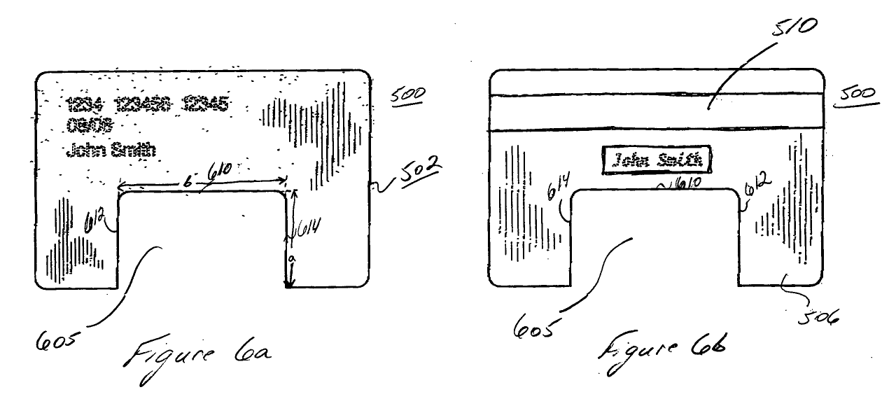

FIG. 6a illustrates a front view of exemplary data card 500 without secondary data card 504 removably engaged with primary data card 503 and FIG. 6b illustrates a rear view of exemplary data card 500 shown in FIG. 5a. Primary data card 503 includes cut-out portion 605. Cut-out portion 605 is formed by three inner walls of primary data card 502—horizontal top wall 610 having length b and vertical sidewalls 612, 614 having length a. As can be seen in FIGS. 6a and 6b, cut-out portion 605 does not include a bottom wall. Rather, when secondary data card is fully inserted within cut-out portion 605, horizontal bottom wall 520b of secondary data card 504 aligns with or substantially aligns with horizontal bottom wall 516b of primary data card 502.

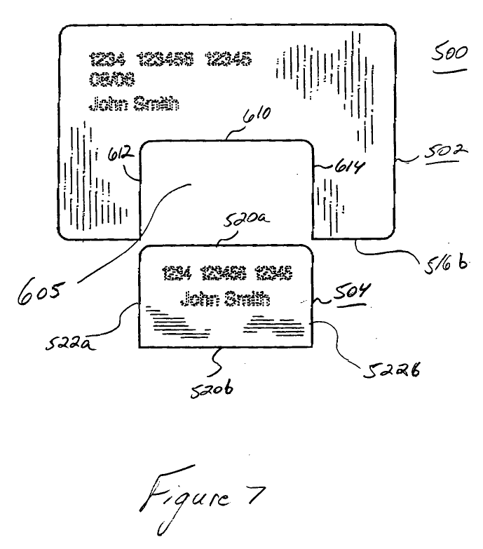

FIG. 7 illustrates another front view of exemplary data card 500 with primary data card 502 disengaged from secondary data card 504. In order to engage secondary data card 504 with primary data card 502, the vertical outer walls 522a, 522b of secondary data card 504 are aligned with or substantially aligned with the vertical sidewalls 612, 614 of cut-out portion 605. Thereafter, secondary data card 504 is inserted into cut-out portion 605 until horizontal bottom edge 520b of secondary data card 504 is aligned with or substantially aligned with horizontal bottom edge 516b of primary data card 502, as shown in FIGS. 5a and 5b.

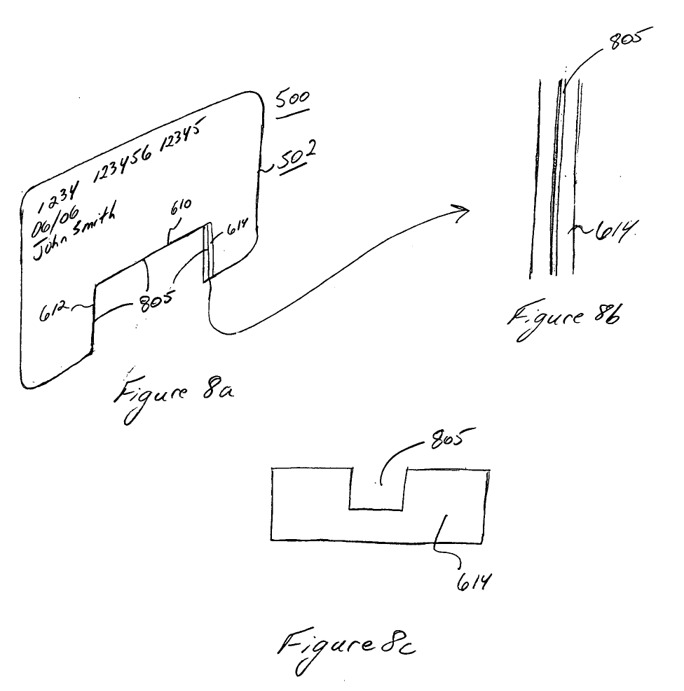

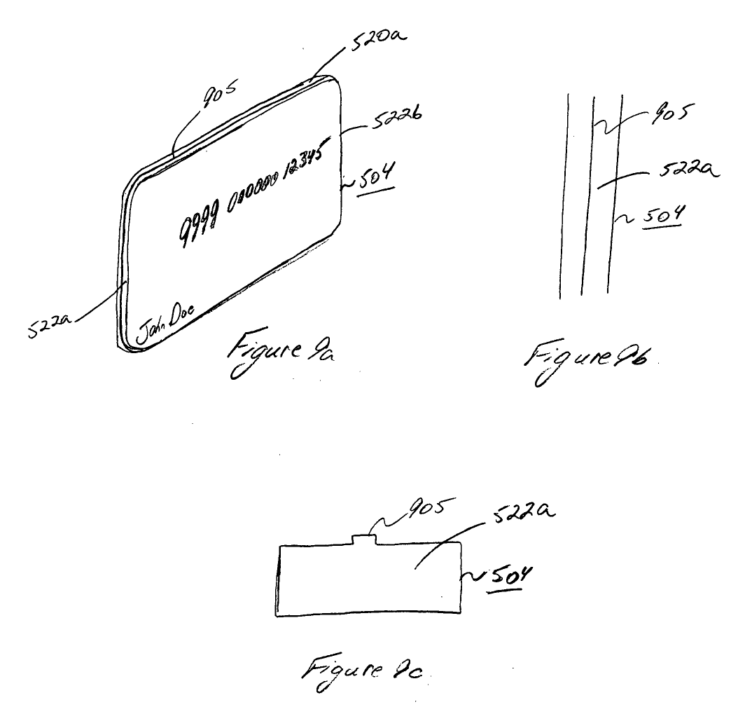

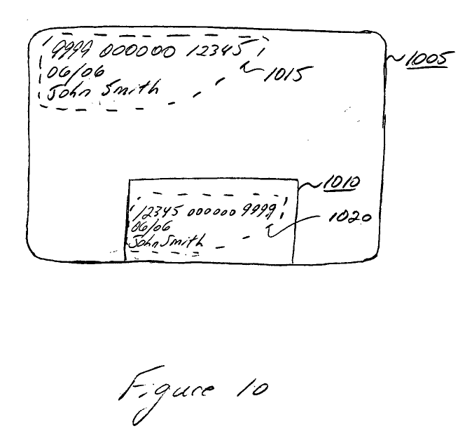

FIGS. 8a, 8b, 8c and FIGS. 9a, 9b, 9c illustrate an exemplary method for secondary data card 504 to be removably engaged with primary data card 502. As can be seen in FIG. 8a, inner walls 610, 612, 614 of primary data card 502 include groove 805 around at least a portion of the inner walls. Groove 805 can be located along the entire inner side walls 612, 614 or a portion of the inner side walls 612, 614. Further, groove 805 may or may not be located along inner horizontal wall 610 and if located along inner horizontal wall 610, either the entire inner horizontal wall 610 or a portion thereof may include groove 805. FIGS. 8b and 8c depict groove 805 located along inner side wall 614. The width, depth and shape of groove 805 depends on the width, depth and shape of tongue 905 described herein with reference to FIGS. 9a, 9b, 9c.

FIG. 9a illustrates an exemplary secondary data card 504 having tongue 905 along horizontal top wall 520a and vertical side walls 522a, 522b. Tongue 905 can be located around the entire vertical side walls 522a, 522b or a portion of the vertical side walls 522a, 522b. Further, tongue 905 may or may not be located along horizontal wall 520a and if located along horizontal wall 520a, either the entire horizontal wall 520a or a portion thereof may include tongue 905. FIGS. 9b and 9c depict tongue located along inner side wall 522a. The width, depth and shape of tongue 905 depends on the width, depth and shape of groove 805 described herein with reference to FIGS. 8a, 8b, 8c. Alternatively, secondary data card 504 includes tongue 905 around a portion of its walls 520a, 522a, 522b that is less than a portion of the walls 610, 612, 614 having groove 805. Thus, at least a portion of groove 805 will not have inserted therein tongue 905 when secondary data card 504 is fully inserted into primary data card 502. The interaction of groove 805 with tongue 905 prevents secondary data card 504 from being intentionally or inadvertently pushed through cut-out portion 605 of the primary data card 502.

In an exemplary embodiment, secondary data card 504 firmly fits into cut-out portion 605 of primary data card 502, as shown in FIGS. 5a and 5b. Specifically, when secondary data card 504 is engaged with primary data card 502, horizontal top wall 520a of secondary data card 504 remains in contact with horizontal inner top wall 610 of cut-out portion 605, horizontal bottom wall 520b of secondary data card 504 aligns with or substantially aligns with horizontal bottom wall 516b of cut-out portion 605, vertical side wall 522a of secondary data card 504 remains in contact with vertical inner side wall 612 of cut-out portion 605, and vertical side wall 522b of secondary data card 504 remains in contact with vertical inner side wall 614 of cut-out portion 605. Thus, due to the dimensions of the secondary data card 504, secondary data card 504 rests firmly within cut-out portion 605 of primary data card 502. In an exemplary embodiment, secondary data card 115 can be removably engaged such that front face 140 is coplanar with front face 138 or rear face 110 of primary data card 105. Also, secondary data card 115 can be removably engaged with primary data card 105 so that its orientation is 180 degrees from what is shown in the figures. In order to disengage secondary data card 504 from primary data card 502, for instance, an individual exerts opposing forces on secondary data card 504 and primary data card 502 so that secondary data card 504 is slid out from primary data card 502.

The location of the cut-out portion 605 is merely exemplary, as is the size and shape of the cut-out portion 605 and the size and shape of secondary data card 502. Further, as shown in the figures, magnetic recordable data strips 510, 515 can be configured on primary data card 502 and the respective secondary data card 504 in various ways.

Primary data card 502 is operable, for example, at a POS terminal and an ATM, as the dimensions of primary data card 502 and the location of magnetic recordable data strip 510 are in compliance with regulations imposed by ISO. Further, primary data card 502 is operable at POS terminals when cut-out portion 605 does or does not contain secondary data card 504 since the swiping of magnetic recordable data strip 510 at these POS terminals is not effected. Further, primary data card 502 is operable at ATM machines when cut-out portion 605 does not contain secondary data card 504 if, for example, the absence of secondary data card 504 does not effect the functioning of the ATM machines for determining the presence of primary data card 502 upon insertion into a card reading port associated with the ATM machines by an individual. Primary data card 502 is also operable at ATM machines when cut-out portion 605 contains secondary data card 504.

Similarly, secondary data card 504 is also operable at POS terminals by, for example, swiping magnetic recordable data trip 515. As can be seen in the figures of the present application, secondary data card 504 and its associated magnetic recordable data strip 515 have smaller dimensions than primary data card 502. Accordingly, as will be appreciated by a person having ordinary skill in the art, magnetic recordable data strip 515 is encoded with account data along a smaller recording medium. U.S. Pat. No. 6,471,127 to Pentz et al., which is incorporated herein by reference in its entirety, describes encoding data on a magnetic recordable data strip smaller than a conventional magnetic recordable data strip.

Therefore, according to the exemplary embodiments of the present application, an individual can conduct transactions with primary data card 502 at an ATM machine and at a POS terminal, regardless whether secondary data card 504 is removably engaged within cut-out portion 605 of primary data card 502. Moreover, the individual can disengage secondary data card 504 for conducting transactions with secondary data card 504 at POS terminals. As will be appreciated by a person having ordinary skill in the art, if secondary data card 504 is engaged with primary data card 502 so that magnetic recordable data strip 515 is located along horizontal bottom wall 516b, secondary data card 504 is also operable at a POS terminal upon swiping primary data card 502 so that magnetic recordable data strip 515 is read by the respective magnetic reading head. Magnetic recordable data strip 510 and magnetic recordable data strip 515 are encoded with the same or similar data for accessing the same account.

In an alternative embodiment of the present application, magnetic recordable data data strip 510 of primary data card 502 and magnetic recordable data strip 515 of the corresponding secondary data card 504 are encoded with data for accessing different accounts, like the exemplary data card shown in FIG. 10. Indicia associated with a primary data card and indicia associated with a secondary data card may or may not reflect the operability of these cards to access different accounts. For instance, the primary data card can be operable for accessing a checking account and the secondary data card can be operable for accessing a savings account. As will be appreciated by a person having ordinary skill in the art, the primary data card and the secondary data card can be operable for accessing various types of accounts, whether financial or otherwise.

In another alternative embodiment of the present application, a lip can be located around at least two walls of cut-out portion 605, as described herein with respect to the exemplary embodiment shown in FIG. 1a through FIG. 4, instead of or in combination with a groove or a tongue.

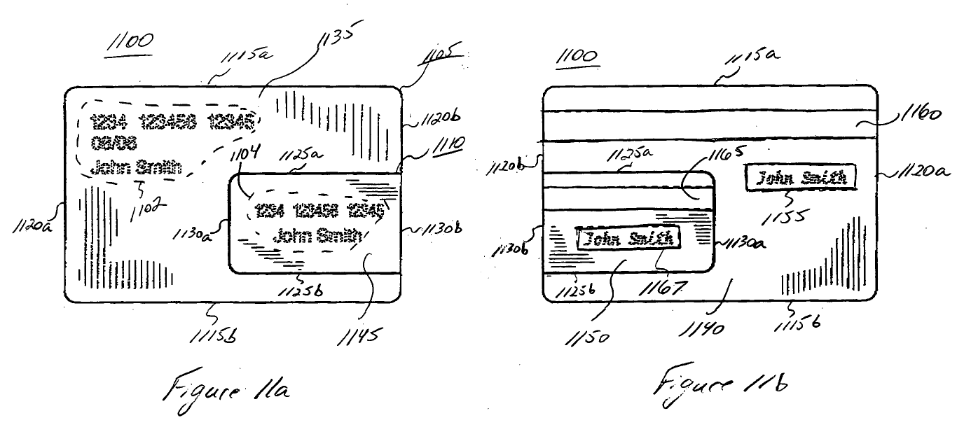

FIG. 11a illustrates a front view of exemplary data card 1100 according to the exemplary embodiments of the present application and FIG. 11b illustrates a rear view of exemplary data card 1100. As can be seen in FIGS. 11a and 11b, exemplary data card 1100 includes primary data card 1105 removably engaged with secondary data card 1110, primary data card 1105 and secondary data card 1110 having one common wall located on the right side of data card 1100 when looking at front face 1135, as described herein in more detail. Primary data card 1105 includes front face 1135, rear face 1140, and four outer walls—horizontal top wall 1115a, horizontal bottom wall 1115b, vertical side wall 1120a and vertical side wall 1120b. Secondary data card 1110 includes front face 1145, rear face 1150, and four outer walls—horizontal top wall 1125a, horizontal bottom wall 1125b, vertical side wall 1130a and vertical side wall 1130b.

Front face 1135 of primary data card 1105 includes indicia 1102 and front face 1145 of secondary data card 1110 includes indicia 1104. In an exemplary embodiment, indicia 1102, 1104 identifies an account and an account holder associated with primary data card 1105 and secondary data card 1110. Indicia 1105, 1110 can include, for example, data indicating a name, account number, expiration date, and an institution, a merchant or the like issuing the data card. Rear face 1140 of primary data card 1105 includes magnetic recordable data strip 1160 and signature box 1155. Likewise, rear face 1150 of secondary data card 1110 includes magnetic recordable data strip 1165 and signature box 1167. Alternatively, either signature box 1155 or signature box 1167 can be included on data card 1100 and can be located on rear face 1140 or rear face 1150 of primary data card 1105 or secondary data card 1110, respectively. Magnetic recordable data strip 1160 and magnetic recordable data strip 1165 are encoded with data such that primary data card 1105 and secondary data card 1110, respectively, are operable for a cardholder to access the same account.

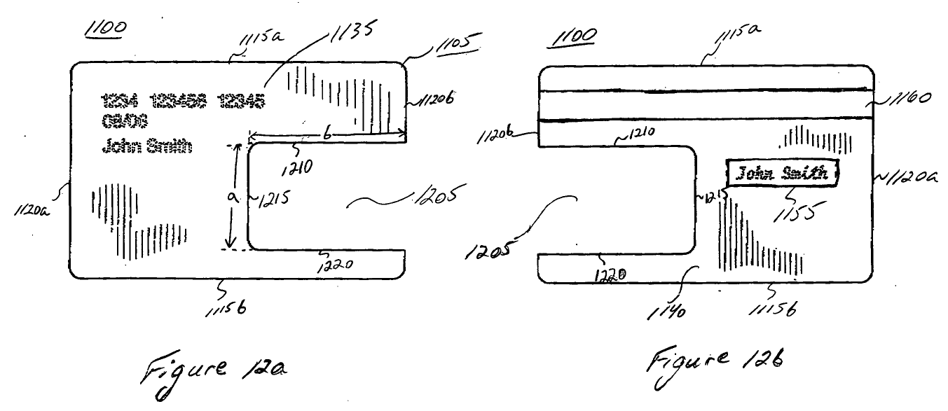

FIG. 12a illustrates a front view of exemplary data card 1100 without secondary data card 1110 removably engaged with primary data card 1105 and FIG. 6b illustrates a rear view of exemplary data card 1100 shown in FIG. 5a. Primary data card 1105 includes cut-out portion 1205. Cut-out portion 1205 is formed by three inner walls of primary data card 1105—horizontal top wall 1210 and horizontal bottom wall 1220 having length b and vertical sidewall 1215 having length a. As can be seen in FIGS. 12a and 12b, cut-out portion 1205 does not include one side wall. Rather, when secondary data card 1110 is fully inserted within cut-out portion 1205, vertical sidewall 1130b of secondary data card 1110 aligns with or substantially aligns with vertical sidewall 1120b of primary data card 1105.

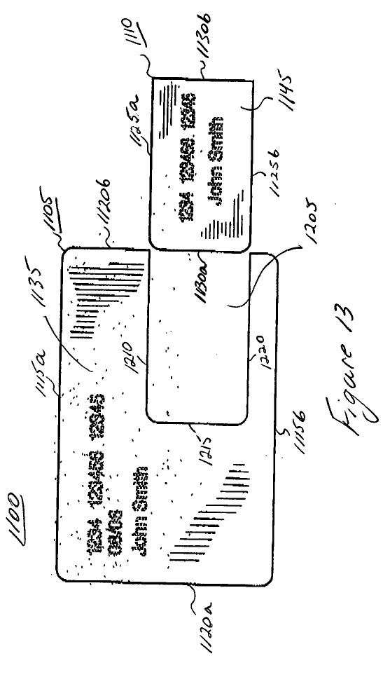

FIG. 13 illustrates another front view of exemplary data card 1100 with primary data card 1105 disengaged from secondary data card 1110. In order to engage secondary data card 1110 with primary data card 1105, horizontal outer walls 1125a, 1125b of secondary data card 1110 are aligned with or substantially aligned with the horizontal inner sidewalls 1210, 1220 of cut-out portion 1205. Thereafter, secondary data card 1110 is inserted into cut-out portion 1205 until vertical sidewall 1130b of secondary data card 1110 is aligned with or substantially aligned with vertical sidewall 1120b of primary data card 1105, as shown in FIGS. 11a and 11b

For exemplary data card 1100, secondary data card 1110 is removably engaged and disengaged with primary data card 1105 using a groove and a tongue as described herein with reference to FIGS. 8a, 8b, 8c and FIGS. 9a, 9b, 9c. Hence, the use of a tongue and groove are not again described for this exemplary embodiment.

In an exemplary embodiment, secondary data card 1110 firmly fits into cut-out portion 1205 of primary data card 1105, as shown in FIGS. 11a and 11b. Specifically, when secondary data card 1110 is engaged with primary data card 1105, horizontal top wall 1125a of secondary data card 1110 remains in contact with horizontal inner top wall 1210 of cut-out portion 1205, horizontal bottom wall 1125b of secondary data card 1110 remains in contact with horizontal bottom wall 1220 of cut-out portion 1205, and vertical side wall 1130a of secondary data card 1110 remains in contact with vertical inner side wall 1215 of cut-out portion 1205. Thus, due to the dimensions of the secondary data card 1110, secondary data card 1110 rests firmly within cut-out portion 1205 of primary data card 1105. In an exemplary embodiment, secondary data card 115 can be removably engaged such that front face 140 is coplanar with front face 138 or rear face 110 of primary data card 105. Also, secondary data card 115 can be removably engaged with primary data card 105 so that its orientation is 180 degrees from what is shown in the figures. In order to disengage secondary data card 1110 from primary data card 1105, for instance, an individual exerts opposing forces on secondary data card 1110 and primary data card 1105 so that secondary data card 1110 is slid out from primary data card 1105.

The location of the cut-out portion 1205 is merely exemplary, as is the size and shape of the cut-out portion 1205 and the size and shape of secondary data card 1110. Further, as shown in the figures, magnetic recordable data strips 1160, 1165 can be configured on primary data card 1105 and the respective secondary data card 1110 in various ways.

Primary data card 1105 is operable, for example, at a POS terminal and an ATM, as the dimensions of primary data card 1105 and the location of magnetic recordable data strip 1160 are in compliance with ISO standards. Further, primary data card 1105 is operable at POS terminals when cut-out portion 1205 does or does not contain secondary data card 1110 since the swiping of magnetic recordable data strip 1160 at these POS terminals is not effected. Further, primary data card 1105 is operable at ATM machines when cut-out portion 1205 does not contain secondary data card 1110 if, for example, the absence of secondary data card 1110 does not effect the functioning of the ATM machines for determining the presence of primary data card 1105 upon insertion into a card reading port associated with the ATM machines by an individual. Primary data card 1105 is also operable at ATM machines when cut-out portion 1205 contains secondary data card 1110.

Similarly, secondary data card 1110 is also operable at POS terminals by, for example, swiping magnetic recordable data strip 1165. As can be seen in the figures of the present application, secondary data card 1110 and its associated magnetic recordable data strip 1165 have smaller dimensions than primary data card 1105. Accordingly, as will be appreciated by a person having ordinary skill in the art, magnetic recordable data strip 1165 is encoded with account data along a smaller recording medium. U.S. Pat. No. 6,471,127 to Pentz et al., which is incorporated herein by reference in its entirety, describes encoding data on a magnetic recordable data strip smaller than a conventional magnetic recordable data strip.

Therefore, according to the exemplary embodiments of the present application, an individual can conduct transactions with primary data card 1105 at an ATM machine and at a POS terminal, regardless whether secondary data card 1110 is removably engaged within cut-out portion 1205 of primary data card 1105. Moreover, the individual can disengage secondary data card 1110 for conducting transactions with secondary data card 1110 at POS terminals. As will be appreciated by a person having ordinary skill in the art, if secondary data card 1110 is engaged with primary data card 1105 so that magnetic recordable data strip 1165 is located along horizontal bottom wall 1115b, secondary data card 1110 is also operable at a POS terminal upon swiping primary data card 1105 so that magnetic recordable data strip 1165 is read by the respective magnetic reading head. Magnetic recordable data strip 1160 and magnetic recordable data strip 1165 are encoded with the same or similar data for accessing the same account.

In an alternative embodiment of the present application, magnetic recordable data data strip 1160 of primary data card 1105 and magnetic recordable data strip 1165 of the corresponding secondary data card 1110 are encoded with data for accessing different accounts, like the exemplary data card shown in FIG. 10. Indicia associated with a primary data card and indicia associated with a secondary data card may or may not reflect the operability of these cards to access different accounts. For instance, the primary data card can be operable for accessing a checking account and the secondary data card can be operable for accessing a savings account. As will be appreciated by a person having ordinary skill in the art, the primary data card and the secondary data card can be operable for accessing various types of accounts, whether financial or otherwise.

In another alternative embodiment of the present application, a lip can be located around at least two walls of cut-out portion 1205, as described herein with respect to the exemplary embodiment shown in FIG. 1a through FIG. 4, instead of or in combination with a groove or a tongue.

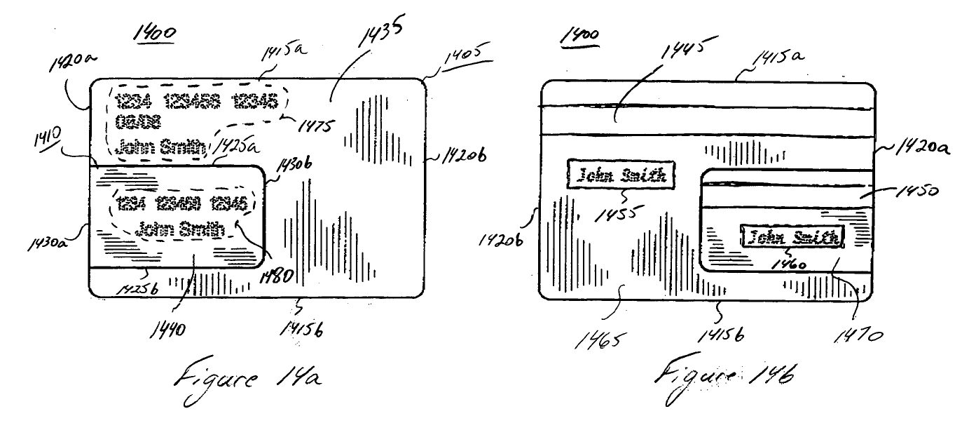

FIG. 14a illustrates a front view of exemplary data card 1400 according to the exemplary embodiments of the present application and FIG. 14b illustrates a rear view of exemplary data card 1400. As can be seen in FIGS. 14a and 14b, exemplary data card 1400 includes primary data card 1405 removably engaged with secondary data card 1410, primary data card 1405 and secondary data card 1410 having one common wall located on the left side of data card 1400 when looking at front face 1435, as described herein in more detail. Primary data card 1405 includes front face 1435, rear face 1465, and four outer walls—horizontal top wall 1415a, horizontal bottom wall 1415b, vertical side wall 1420a and vertical side wall 1420b. Secondary data card 1410 includes front face 1440, rear face 1470, and four outer walls—horizontal top wall 1425a, horizontal bottom wall 1425b, vertical side wall 1430a and vertical side wall 1430b.

Front face 1435 of primary data card 1405 includes indicia 1475 and front face 1440 of secondary data card 1410 includes indicia 1480. In an exemplary embodiment, indicia 1475, 1480 identifies an account and an account holder associated with primary data card 1405 and secondary data card 1410. Indicia 1475, 1480 can include, for example, data indicating a name, account number, expiration date, and an institution, a merchant or the like issuing the data card. Rear face 1465 of primary data card 1405 includes magnetic recordable data strip 1145 and signature box 1455. Likewise, rear face 1470 of secondary data card 1110 includes magnetic recordable data strip 1450 and signature box 1460. Alternatively, either signature box 1455 or signature box 1460 can be included on data card 1400 and can be located on rear face 1465 or rear face 1470 of primary data card 1405 or secondary data card 1410, respectively. Magnetic recordable data strip 1445 and magnetic recordable data strip 1450 are encoded with data such that primary data card 1405 and secondary data card 1410, respectively, are operable for a cardholder to access the same account.

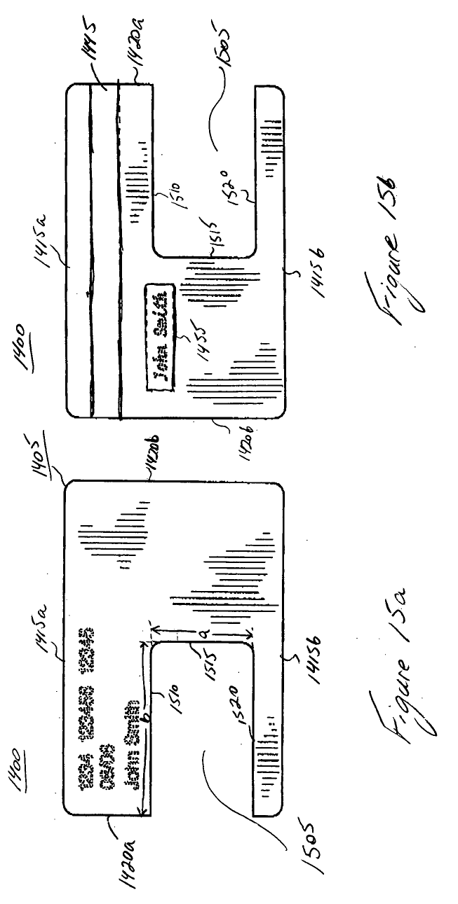

FIG. 15a illustrates a front view of exemplary data card 1400 without secondary data card 1410 removably engaged with primary data card 1405 and FIG. 15b illustrates a rear view of exemplary data card 1400 shown in FIG. 15a. Primary data card 1405 includes cut-out portion 1505. Cut-out portion 1505 is formed by three inner walls of primary data card 1405—horizontal top wall 1510 and horizontal bottom wall 1520 having length b and vertical sidewall 1515 having length a. As can be seen in FIGS. 15a and 15b, cut-out portion 1505 does not include one side wall. Rather, when secondary data card 1410 is fully inserted within cut-out portion 1505, vertical sidewall 1430a of secondary data card 1410 aligns with or substantially aligns with vertical sidewall 1420a of primary data card 1405.

FIG. 16 illustrates another front view of exemplary data card 1400 with primary data card 1405 disengaged from secondary data card 1410. In order to engage secondary data card 1410 with primary data card 1405, horizontal outer walls 1425a, 1425b of secondary data card 1410 are aligned with or substantially aligned with the horizontal inner sidewalls 1510, 1520 of cut-out portion 1505. Thereafter, secondary data card 1410 is inserted into cut-out portion 1505 until vertical sidewall 1430a of secondary data card 1410 is aligned with or substantially aligned with vertical sidewall 1420a of primary data card 1405, as shown in FIGS. 14a and 14b.

For exemplary data card 1400, secondary data card 1410 is removably engaged and disengaged with primary data card 1405 using a groove and a tongue as described herein with reference to FIGS. 8a, 8b, 8c and FIGS. 9a, 9b, 9c. Hence, these methods and components are not again described for this exemplary embodiment.

In an exemplary embodiment, secondary data card 1410 firmly fits into cut-out portion 1505 of primary data card 1405, as shown in FIGS. 14a and 14b. Specifically, when secondary data card 1410 is engaged with primary data card 1405, horizontal top wall 1425a of secondary data card 1410 remains in contact with horizontal inner top wall 1510 of cut-out portion 1505, horizontal bottom wall 1425b of secondary data card 1410 remains in contact with horizontal bottom wall 1520 of cut-out portion 1505, and vertical side wall 1430a of secondary data card 1410 remains in contact with vertical inner side wall 1515 of cut-out portion 1505. Thus, due to the dimensions of the secondary data card 1410, secondary data card 1410 rests firmly within cut-out portion 1505 of primary data card 1405. In an exemplary embodiment, secondary data card 1410 can be removably engaged such that front face 1440 is coplanar with front face 1435 or rear face 1465 of primary data card 1405. Also, secondary data card 1410 can be removably engaged with primary data card 1405 so that its orientation is 180 degrees from what is shown in the figures. In order to disengage secondary data card 1410 from primary data card 1405, for instance, an individual exerts opposing forces on secondary data card 1410 and primary data card 1405 so that secondary data card 1410 is slid out from primary data card 1405.

The location of the cut-out portion 1505 is merely exemplary, as is the size and shape of the cut-out portion 1505 and the size and shape of secondary data card 1410. Further, as shown in the figures, magnetic recordable data strips 1445, 1450 can be configured on primary data card 1405 and the respective secondary data card 1410 in various ways.

Primary data card 1405 is operable, for example, at a POS terminal and an ATM, as the dimensions of primary data card 1405 and the location of magnetic recordable data strip 1445 are in compliance with ISO standards. Further, primary data card 1405 is operable at POS terminals when cut-out portion 1505 does or does not contain secondary data card 1410 since the swiping of magnetic recordable data strip 1445 at these POS terminals is not effected. Further, primary data card 1405 is operable at ATM machines when cut-out portion 1505 does not contain secondary data card 1410 if, for example, the absence of secondary data card 1410 does not effect the functioning of the ATM machines for determining the presence of primary data card 1405 upon insertion into a card reading port associated with the ATM machines by an individual. Primary data card 1405 is also operable at ATM machines when cut-out portion 1505 contains secondary data card 1410.

Similarly, secondary data card 1410 is also operable at POS terminals by, for example, swiping magnetic recordable data strip 1450. As can be seen in the figures of the present application, secondary data card 1410 and its associated magnetic recordable data strip 1450 have smaller dimensions than primary data card 1405. Accordingly, as will be appreciated by a person having ordinary skill in the art, magnetic recordable data strip 1450 is encoded with account data along a smaller recording medium. U.S. Pat. No. 6,471,127 to Pentz et al., which is incorporated herein by reference in its entirety, describes encoding data on a magnetic recordable data strip smaller than a conventional magnetic recordable data strip.

Therefore, according to the exemplary embodiments of the present application, an individual can conduct transactions with primary data card 1405 at an ATM machine and at a POS terminal, regardless whether secondary data card 1410 is removably engaged within cut-out portion 1505 of primary data card 1405. Moreover, the individual can disengage secondary data card 1410 for conducting transactions with secondary data card 1410 at POS terminals. As will be appreciated by a person having ordinary skill in the art, if secondary data card 1110 is engaged with primary data card 1105 so that magnetic recordable data strip 1165 is located along horizontal bottom wall 1115b, secondary data card 1110 is also operable at a POS terminal upon swiping primary data card 1105 so that magnetic recordable data strip 1165 is read by the respective magnetic reading head. Magnetic recordable data strip 1445 and magnetic recordable data strip 1150 are encoded with the same or similar data for accessing the same account.

In an alternative embodiment of the present application, magnetic recordable data strip 1145 of primary data card 1405 and magnetic recordable data strip 1450 of the corresponding secondary data card 1410 are encoded with data for accessing different accounts, like the exemplary data card shown in FIG. 10. Indicia associated with a primary data card and indicia associated with a secondary data card may or may not reflect the operability of these cards to access different accounts. For instance, the primary data card can be operable for accessing a checking account and the secondary data card can be operable for accessing a savings account. As will be appreciated by a person having ordinary skill in the art, the primary data card and the secondary data card can be operable for accessing various types of accounts, whether financial or otherwise.

In an alternative embodiment of the present application, groove 805 can be located on secondary data card 504 and tongue 905 can be located on primary card 502. Similarly, primary data card 1105 and secondary data card 1110, and primary data card 1405 and secondary data card 1410, can have a grove on the respective secondary card and a tongue on the respective primary card.

In another alternative embodiment of the present application, a lip can be located around at least two walls of cut-out portion 1505, as described herein with respect to the exemplary embodiment shown in FIG. 1a through FIG. 4, instead of or in combination with a groove or a tongue.

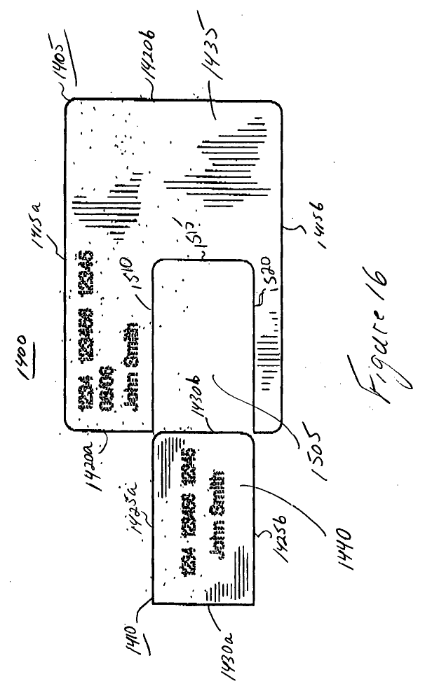

FIGS. 17a and 17b illustrate exemplary data card 1700. Exemplary data card 1700 includes primary data card 1720 and secondary data card 1710. Exemplary data card 1700 is the same as exemplary data card 100, except that secondary data card 1710 includes processing unit and memory unit 1705, instead of a magnetic recordable data strip like secondary data card 115. FIG. 17b illustrates rear face 1730 of primary data card 1720 and rear face 1735 of secondary data card 1710. Rear face 1730 includes magnetic recordable data strip 1725. The implementation and functionality of processing units and memory units such as processing unit and memory unit 1705 are well known in the art and are therefore not described herein. For instance, such processing units and memory units are commonly incorporated into data cards often referred to as smart cards. As depicted in FIGS. 17a and 17b, secondary data card 1710 is surrounded by four inner walls of primary data card 1720, like secondary data card 115 described and illustrated herein. As will be appreciated by a person having ordinary skill in the art, however, primary data card 1720 can be operable for removably engaging secondary data card 1710, as shown in FIGS. 5a through 16.

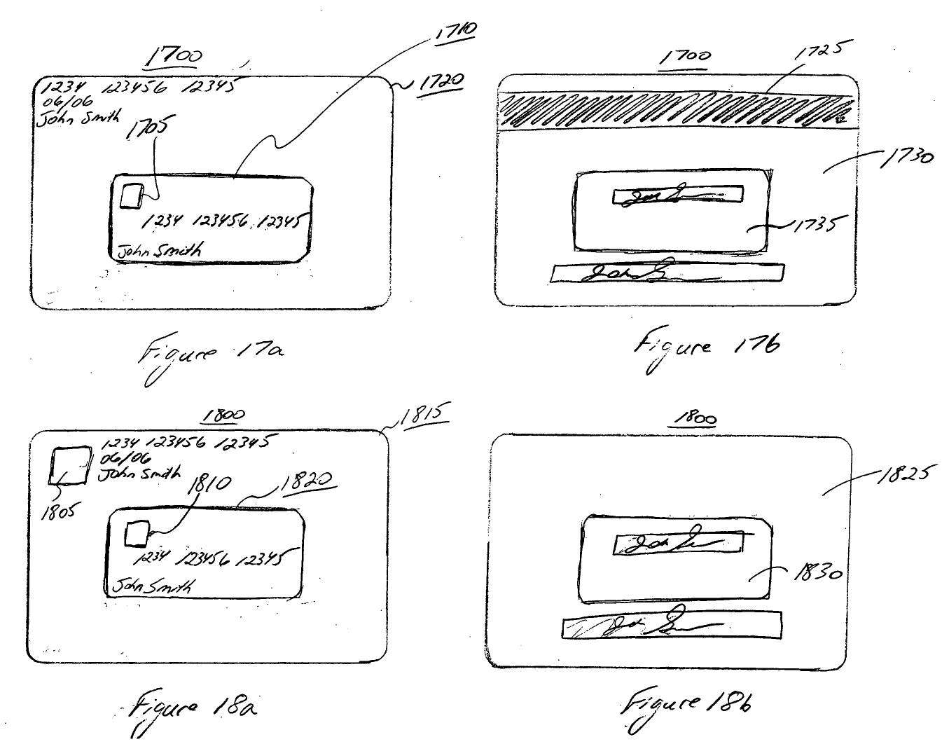

FIGS. 18a and 18b illustrate exemplary data card 1800. Exemplary data card 1800 includes primary data card 1815 and secondary data card 1820. Exemplary data card 1800 is the same as exemplary data card 100, except that primary data card 1815 and secondary data card 1820 includes processing unit and memory unit 1805, 1810, respectively, instead of a magnetic recordable data strip like primary data card 105 and secondary data card 115. FIG. 18b illustrates rear face 1730 of primary data card 1720 and rear face 1735 of secondary data card 1710. The implementation and functionality of processing units and memory units such as processing unit and memory unit 1805, 1810 are well known in the art and are therefore not described herein. For instance, such processing units and memory units are commonly incorporated into data cards often referred to as smart cards. As depicted in FIGS. 17a and 17b, secondary data card 1710 is surrounded by four inner walls of primary data card 1720, like secondary data card 115 described and illustrated herein. As will be appreciated by a person having ordinary skill in the art, however, primary data card 1720 can be operable for removably engaging secondary data card 1710, as shown in FIGS. 5a through 16.

Further, the magnetic data strip and/or the processing unit(s) shown in FIGS. 17a, 17b, 18a, 18b can be configured on the primary card and the respective secondary card in various ways. In an alternative embodiment, the primary card and the corresponding secondary card can also access different accounts due to data encoded and/or stored in the respective magnetic data strips and/or processing units.

In the exemplary embodiments of the present application, the exemplary secondary data cards are removably engaged with the corresponding primary data cards by either a tongue and groove mechanism or a lip mechanism. As will be appreciated by a person having ordinary skill in the art, the present application is not limited to these two manners of removable engaging the respective data cards.

What is claimed is:

1. A data card, comprising:
a primary card body including a first magnetic recordable data strip, the primary card body having a cut-out portion; and
a secondary card body including a second magnetic recordable data strip, the secondary card body operable to be removably engaged within the cut-out portion of the primary card body.

2. The data card as set forth in claim 1, wherein
the primary card body includes a front face, a back face, an exterior horizontal top wall, an exterior horizontal bottom wall and a pair of exterior vertical side walls, and
the cut-out portion is formed by an interior horizontal top wall, an interior horizontal bottom wall and a pair of interior vertical side walls of the primary card body.

3. The data card as set forth in claim 2, wherein
the primary card body includes a lip, the lip being located along the interior horizontal top wall, the interior horizontal bottom wall and the pair of interior vertical side walls, and being operable for engaging the secondary card body.

4. The data card as set forth in claim 3, wherein
a face of the lip is coplanar with one of the front face and the back face of the primary card body.

5. The data card as set forth in claim 1, wherein
the first magnetic recordable data strip is encoded with account data and is operable at a point of sale terminal for accessing an account when the secondary card body is one of engaged and disengaged from the primary card body, and
the second magnetic recordable data strip is encoded with account data and is operable at the point of sale terminal for accessing one of the account and another account when the secondary card body is disengaged from the primary card body.

6. The data card as set forth in claim 5, wherein
the account and the other account are financial accounts associated with one of a credit line and deposited funds.

7. The data card as set forth in claim 1, wherein
the first magnetic recordable data strip is encoded with account data and is operable at an automated teller machine for accessing an account when the secondary card body is engaged with the primary card body.

8. The data card as set forth in claim 1, wherein
the first magnetic recordable data strip is encoded with account data and is operable at an automated teller machine for accessing an account when the secondary card body is disengaged from the primary card body.

9. The data card as set forth in claim 1, wherein
the primary card body includes an exterior horizontal top wall, an exterior horizontal bottom wall and a pair of exterior vertical side walls, and
the cut-out portion is formed by an interior horizontal top wall and a pair of interior vertical side walls of the primary card body.

10. The data card as set forth in claim 9, wherein
the secondary card body includes an exterior horizontal top wall, an exterior horizontal bottom wall and a pair of exterior vertical side walls.

11. The data card as set forth in claim 10, wherein
at least two walls of the interior horizontal top wall and the pair of interior vertical side walls include a tongue, and
at least two walls of the exterior horizontal top wall, the exterior horizontal bottom wall and the pair of exterior vertical side walls include a groove operable for receiving the tongue and engaging the primary card body.

12. The data card as set forth in claim 10, wherein
at least two walls of the interior horizontal top wall and the pair of interior vertical side walls include a groove, and
at least two walls of the exterior horizontal top wall, the exterior horizontal bottom wall and the pair of exterior vertical side walls include a tongue operable for insertion into the groove and engaging the primary card body.

13. The data card as set forth in claim 10, wherein
the primary card body includes a lip, the lip being located along the interior horizontal top wall and the pair of interior vertical side walls, and being operable for engaging the secondary card body.

14. The data card as set forth in claim 13, wherein
the primary card body includes a front face and a back face, and
a face of the lip is coplanar with one of the front face and the back face of the primary card body.

15. The data card as set forth in claim 9, wherein
the first magnetic recordable data strip is encoded with account data and is operable at a point of sale terminal for accessing an account when the secondary card body is one of engaged and disengaged from the primary card body, and
the second magnetic recordable data strip is encoded with account data and is operable at the point of sale terminal for accessing one of the account and another account when the secondary card body is one of engaged and disengaged from the primary card body.

16. The data card as set forth in claim 15, wherein
the account and the other account are financial accounts associated with one of a credit line and deposited funds.

17. The data card as set forth in claim 9, wherein
the first magnetic recordable data strip is encoded with account data and is operable at an automated teller machine for accessing an account when the secondary card body is engaged with the primary card body.

18. The data card as set forth in claim 9, wherein
the first magnetic recordable data strip is encoded with account data and is operable at an automated teller machine for accessing an account when the secondary card body is disengaged from the primary card body.

19. The data card as set forth in claim 1, wherein
the primary card body includes an exterior horizontal top wall, an exterior horizontal bottom wall and a pair of exterior vertical side walls, and
the cut-out portion is formed by an interior horizontal top wall, an interior horizontal bottom wall and an interior vertical side wall of the primary card body.

20. The data card as set forth in claim 19, wherein
the secondary card body includes an exterior horizontal top wall, an exterior horizontal bottom wall and a pair of exterior vertical side walls.

21. The data card as set forth in claim 20, wherein
at least two walls of the interior horizontal top wall, the interior horizontal bottom wall and the interior vertical side wall include a tongue, and
at least two walls of the exterior horizontal top wall, the exterior horizontal bottom wall and the pair of exterior vertical side walls include a groove operable for receiving the tongue and engaging the primary card body.

22. The data card as set forth in claim 20, wherein
at least two walls of the interior horizontal top wall, the interior horizontal bottom wall and the interior vertical side wall include a groove, and
at least two walls of the exterior horizontal top wall, the exterior horizontal bottom wall and the pair of exterior vertical side walls include a tongue operable for insertion into the groove and engaging the primary card body.

23. The data card as set forth in claim 20, wherein
the primary card body includes a lip, the lip being located along the interior horizontal top wall, the interior horizontal bottom wall and the interior vertical side wall, and being operable for engaging the secondary card body.

24. The data card as set forth in claim 23, wherein
the primary card body includes a front face and a back face, and
a face of the lip is coplanar with one of the front face and the back face.

25. The data card as set forth in claim 19, wherein
the first magnetic recordable data strip is encoded with account data and is operable at a point of sale terminal for accessing an account when the secondary card body is one of engaged and disengaged from the primary card body, and
the second magnetic recordable data strip is encoded with account data and is operable at the point of sale terminal for accessing one of the account and another account when the secondary card body is disengaged from the primary card body.

26. The data card as set forth in claim 25, wherein
the account and the other account are financial accounts associated with one of a credit line and deposited funds.

27. The data card as set forth in claim 19, wherein
the first magnetic recordable data strip is encoded with account data and is operable at an automated teller machine for accessing an account when the secondary card body is engaged with the primary card body.

28. The data card as set forth in claim 19, wherein
the first magnetic recordable data strip is encoded with account data and is operable at an automated teller machine for accessing an account when the secondary card body is disengaged from the primary card body.

29. A data card, comprising:
a primary card body including two exterior vertical side walls, an exterior horizontal top wall, an exterior horizontal bottom wall and a first magnetic recordable data strip, the primary card body having a cut-out portion, the cut-out portion formed by at least three interior walls of the primary card body; and
a secondary card body including two vertical side walls, a horizontal top wall, a horizontal bottom wall and a second magnetic recordable data strip, the secondary card body operable to be removably engaged within the cut-out portion of the primary card body, wherein
the first magnetic recordable data strip is encoded with account data and is operable for accessing an account and the second magnetic recordable data strip is encoded with account data and is operable for accessing one of the account and another account.

30. A data card, comprising:
a primary card body including a first magnetic recordable data strip, the primary card body having a cut-out portion; and
a secondary card body including a processing unit and a memory unit, the secondary card body operable to be removably engaged within the cut-out portion of the primary card body.

31. A data card, comprising:
a primary card body including a processing unit and a memory unit, the primary card body having a cut-out portion; and
a secondary card body including a magnetic recordable data strip, the secondary card body operable to be removably engaged within the cut-out portion of the primary card body.

32. A data card, comprising:
a primary card body including a first processing unit and a first memory unit, the primary card body having a cut-out portion; and
a secondary card body including a second processing unit and a second memory unit, the secondary card body operable to be removably engaged within the cut-out portion of the primary card body.

33. A method for assembling a data card, the method comprising:
aligning a plurality of outer walls of a secondary data card having a magnetic recordable data strip with a plurality of inner walls forming a cut-out portion of a primary data card, the primary data card having a magnetic recordable data strip; and
engaging the secondary data card and the primary data card by compressing the primary data card and the secondary data card until one of a front face and a back face of the secondary data card is one of coplanar and substantially coplanar with one of a front face and a back face of the primary data card.

34. A method for assembling a data card, the method comprising:
aligning an exterior wall of a secondary data card having a magnetic recordable data strip with an opening of a cut-out portion located along an exterior wall of a primary data card so that the primary data card and the secondary data card are coplanar, the primary data card having a magnetic recordable data strip; and
engaging the secondary data card and the primary data card by sliding the secondary data card into the cut-out portion of the primary data card until the exterior wall of the secondary data card makes contact with an interior wall of the cut-out portion.
